(19) United States
(12) Patent Application Publication
(10) Pub. No.: US 2002/0185398 A1
(43) Pub. Date: Dec. 12, 2002

(54) Rotating confectionary dispensing apparatus

(76) Inventor: Lorene Freeman Price, Haines City, FL (US)

Correspondence Address: HENDERSON & STURM LLP, 1213 MIDLAND BUILDING, 206 SIXTH AVENUE, DES MOINES, IA, 50309-4076, US

(21) Appl. No.: 09/875,235

(22) Filed: Jun. 7, 2001

(51) Int. Cl. A23G 1/00

(52) U.S. Cl. 206/389; 426/106; 206/216

(57) ABSTRACT

A rotary confectionary dispensing apparatus (10) including an elongated strand (20) of edible/chewable material (22) wrapped in a coiled fashion around the intermediate portion (31) of a spool member (30) having outwardly flared hub portions (32) (33) provided with central apertures (34) which are adapted to rotatably receive the opposed ends (43) of a pair of support arm elements (42) that extend upwardly from an elongated handle stem element (41); whereby, the consumption of the strand (20) of edible/chewable material (21) will cause the spool member (30) to rotate.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of confectionary dispensing devices in general and in particular to a confectionary dispensing device that accomplishes the dispensing function in a novel rotary fashion.

2. Description of Related Art

As can be seen by reference to the following U.S. Pat. Nos. 6,095,885; 6,090,420; 5,352,470; and, 5,515,998, the prior art is replete with myriad and diverse novelty confectionary support devices wherein at least one of the prior art references has a rotary component.

While all of the aforementioned prior art constructions are more than adequate for the basic purpose and function for which they have been specifically designed, they are uniformly deficient with respect to their failure to provide a simple, efficient, practical, and amusing apparatus that dispenses a string shaped confectionary product from a rotary spool.

As most candy manufacturers are all too well aware, many of the best tasting candies and wholesome alternatives such as fruit based candy substitutes do not meet the levels of commercial success that they should normally warrant, while less tasty alternatives enjoy tremendous commercial success based on a unique method of dispensing the product.

As a consequence of the foregoing situation, there has existed a longstanding need in the confectionary field for a new and improved type of confectionary dispensing apparatus that delivers an elongated strand-like confectionary or fruit substitute product in a particularly amusing and practical manner; and, the provision of such an arrangement is the stated objective of the present invention.

### BRIEF SUMMARY OF THE INVENTION

Briefly stated, the rotary confectionary dispensing apparatus that forms the basis of the present invention comprises in general a foodstuff unit disposed in a coiled fashion on a primary support unit and an auxiliary unit which rotatably suspends the primary support unit in a horizontal fashion as the foodstuff is consumed.

As will be explained in greater detail further on in the specification, the foodstuff unit comprises an elongated strand of chewable/edible material that is wound onto the primary support unit which includes a spool member having a generally cylindrical intermediate portion flanked by a pair of apertured hub portions.

In addition, the auxiliary support unit includes a generally Y-shaped handle member having an elongated handle stem whose upper end is bifurcated into two support arm elements provided with inwardly directed ends that are adapted to be rotatably received in the apertured hub portions of the spool member.

As a result of this arrangement, as the foodstuff unit is consumed by the user, rotary motion will be imparted to the spool member which is horizontally suspended by the handle member thereby providing a unique rotary confectionary dispensing apparatus.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the rotating confectionary dispensing apparatus that forms the basis for the present invention;

FIG. 2 is a perspective view of the apparatus;

FIG. 3 is an isolated perspective view of the confectionary unit installed on the primary confectionary support unit;

FIG. 4 is an isolated perspective view of a coiled confectionary unit; and,

FIG. 5 is a side elevation view of the primary confectionary support unit.

### DETAILED DESCRIPTION OF THE INVENTION

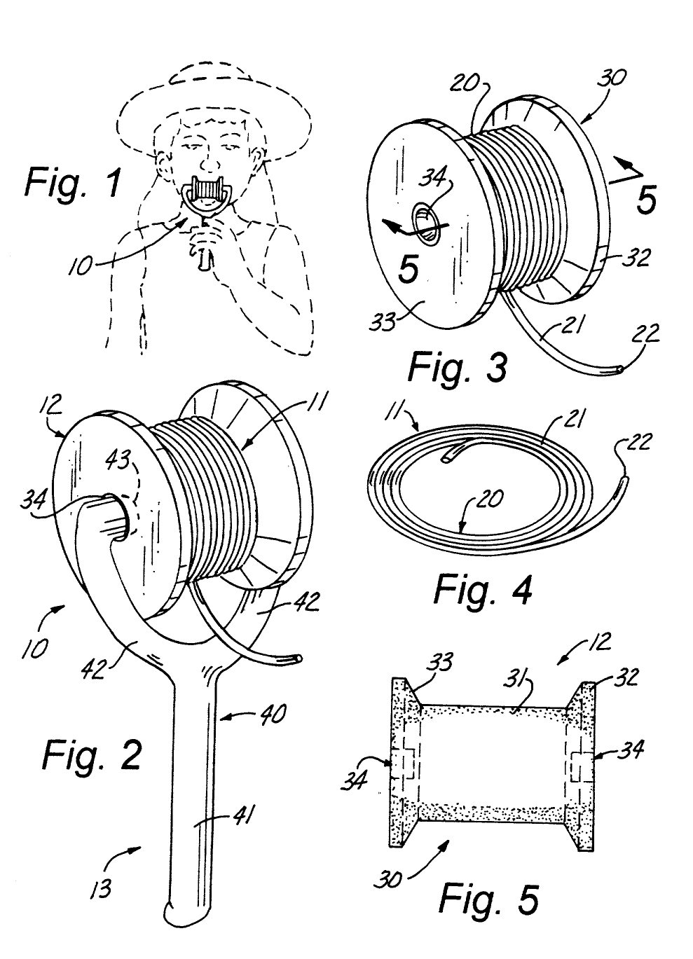

As can be seen by reference to the drawings, and in particularly to FIG. 1, the rotating confectionary dispensing apparatus that forms the basis of the present invention is designated generally by the reference number 10. As shown in FIG. 2, the apparatus 10 comprises in general a foodstuff unit 11, a primary support unit 12, and an auxiliary support unit 13. These units will now be described in seriatim fashion.

As can best be seen by reference to FIGS. 2 through 4, the foodstuff unit 11 comprises an elongated strand 20 of a generally flexible, chewable and/or edible material 21 that is capable of being wound into a coiled configuration. It should also be noted that the material 21 may comprise chewing gum, licorice, processed cheese, meat, fruit, etc., that may be fabricated in an elongated strand configuration.

Turning now to FIGS. 2, 3, and 5, it can be seen that the primary support unit 12 comprises in general a spool member 30 having a generally cylindrical intermediate portion 31 flanked on the opposite ends by a pair of outwardly flared hub portions 32 33 wherein the exterior surfaces of each of the hub portions 32 33 is provided with a central aperture 34 whose purpose and function will be described presently.

As shown in FIGS. 1 and 2, the auxiliary support unit 13 comprises a generally Y-shaped handle member 40 having an elongated handle stem 41 whose upper end is bifurcated into two mirror image support arm elements 42 having inwardly directed opposed ends 43 wherein the opposed ends of the support arm elements 42 are dimensioned to be rotatably received in the central apertures 34 of the hub portions 32 of the spool member 30.

By now it should be appreciated that in use, a manufacturer would provide the consumer with a pre-coiled strand 20 of chewable/edible material 21 on a spool member 30 packaged in a hermetically sealed envelope (not shown).

Then upon removing the spool member 30 from the packaging, the user would force the support arm elements 42 of the Y-shaped handle member 40 apart so that the member 40 could be inserted into the apertures 34 on the spool member 30.

At this point the user would insert the free end 22 of the strand 20 of edible/chewable material into their mouth and as the material is consumed the spool member 30 will rotate on the handle member 40 in a well recognized fashion.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1. A rotary confectionary dispensing apparatus comprising
primary support unit including a spool member having a generally cylindrical intermediate portion and a pair of outwardly flared hub elements
a foodstuff unit including an elongated strand of edible/chewable material disposed in coiled fashion around the intermediate portion of the spool member; and,
means for rotatably suspending the spool member in a generally horizontal fashion.

2. The apparatus as in claim 1 further comprising:
an auxiliary support unit including a handle member having one end operatively associated with at least one of the hub elements to rotatably suspend and support the spool member in a generally horizontal fashion.

3. The apparatus as in claim 1; wherein, at least one of the hub elements of the spool member is provided with a central aperture.

4. The apparatus as in claim 3 further comprising:
an auxiliary support unit including a handle member having one end operatively associated with said central aperture in at least one of the hub elements for suspending the spool member in a generally horizontal fashion.

5. The apparatus as in claim 1; wherein, both of the hub elements of the spool member are provided with central apertures.

6. The apparatus as in claim 5 further comprising:
an auxiliary support unit including a generally Y-shaped handle member adapted to rotatably suspend the spool member in a generally horizontal fashion.

7. The apparatus as in claim 6; wherein, the handle member includes an elongated handle stem having an upper end that is bifurcated into two support arm elements adapted to rotatably receive the hub elements of the spool member.

8. The apparatus as in claim 7; wherein, the support arm elements have inwardly directed opposed ends that are adapted to be rotatably received in the central apertures in the spool member.

9. A method of dispensing a foodstuff unit in a rotary fashion comprising the steps of:
a) fabricating the foodstuff unit into an elongated strand of edible/chewable material,
b) wrapping the elongated strand of edible/chewable material in a coiled fashion about a spool member; and,
c) rotatably suspending the spool member in a generally horizontal fashion from an auxiliary support member.
